(19) United States
(12) Patent Application Publication
(10) Pub. No.: US 2017/0221062 A1
(43) Pub. Date: Aug. 3, 2017

(54) ORDER INSIGHTS SYSTEM AND METHOD

(71) Applicant: VERIFI, INC., Los Angeles, CA (US)

(72) Inventors: Matthew KATZ, Los Angeles, CA (US); Jeff SAWITKE, Los Angeles, CA (US); Manav GUPTA, Los Angeles, CA (US); Chris DEROSSI, Los Angeles, CA (US)

(21) Appl. No.: 15/009,476

(22) Filed: Jan. 28, 2016

(51) Int. Cl. G06Q 20/40; G06Q 30/06

(52) U.S. Cl. CPC G06Q 20/4016; G06Q 30/0637

(57) ABSTRACT

An order insights system and method are disclosed. The system enables real-time access to detailed order, location, and account activity information about a particular transaction for a merchant when a cardholder is questioning a charge or requesting to file a dispute about the particular transaction.

### FIELD

The disclosure relates generally to card based purchase transactions and enables the sharing of information between the cardholder, merchant and financial institution involved with the transaction.

### BACKGROUND

When reviewing a statement or invoice, often a cardholder wants to confirm that a transaction is valid before making a payment to their card issuer. Each transaction has an associated payment descriptor, which includes merchant name and merchant city fields. The payment descriptor is available to the cardholder with a transaction date and amount to assist the cardholder to recognize the purchase. The cardholder is not always able to determine whether the transaction is valid because the cardholder does not recognize the merchant name, is unsure of the transaction amount, or is attempting to recall other order information to confirm that the transaction is valid. The cardholder may contact the issuer for assistance recognizing the transaction.

When a cardholder calls into an issuer's call center, the agent first tries to decipher the payment descriptor on the transaction to determine the merchant from whom the purchase was made. Typically, a call center agent has to determine the identity of the merchant from the payment descriptor by using online search engines. Even if the merchant is identified, the call center agent does not have access to shopping basket details or specifics of what products or services were purchased to assist the cardholder with recognizing the purchase. When the cardholder is not able to recognize the transaction, there is a higher likelihood of the cardholder filing a chargeback. A chargeback is a significant operational overhead for the issuer in addition to a potential revenue loss for either the merchant or the issuer depending on the outcome of the chargeback. It is desirable to provide better information to the cardholder about the transaction to improve the ability for the cardholder to recognize the transaction and reduce the likelihood of a chargeback being filed by the cardholder.

In the case where the details of a transaction include sufficient evidence such that a chargeback is unlikely to be successful, it is desirable to provide the issuer with this information to enable the issuer to select the best course of action. An issuer may avoid the expense of a chargeback by convincing the cardholder that the chargeback will not succeed. Alternatively, the issuer may conclude that writing off the amount of the transaction is the better economic decision compared to pursuing a chargeback that has a low chance of success.

Other uses for this information include supporting issuer obligations to perform reasonable investigation of cardholder disputes. The additional information can also be made available to cardholders in online banking websites or mobile banking applications. Presenting this information in ways which improve the cardholder's recognition of the transactions will reduce operational costs for issuers as well as increase customer satisfaction and the overall customer experience for the cardholder.

### BRIEF DESCRIPTION OF THE DRAWINGS

FIG. 1 illustrates a transaction system that incorporates an order insights system; and

FIG. 2 illustrates the data flows of the components of the order insights system when gathering merchant and transaction information using an advanced acquisition process;

FIG. 3 illustrates the data flows of the order insights system when gathering transaction information using the third party acquisition process;

FIG. 4 illustrates the data flows of the order insights system when processing information in accordance with a real time acquisition approach;

FIG. 5 illustrates the data flows of the order insights system related to aggregated acquisition of merchant information; and

FIG. 6 illustrates the data flows of the order insights system as utilized by payment card issuers.

### DETAILED DESCRIPTION OF ONE OR MORE EMBODIMENTS

The disclosure is particularly applicable to an order insights system integrated into an online banking system, mobile banking application, case management system handling customer service, or case management system handling cardholder disputes. It is in this context that the disclosure will be described. It will be appreciated, however, that the system and method has greater utility, such as to other computer architecture implementations of the system and the order insights system can be a stand-alone system or a cloud based system. The order insights system and method may be used with all card present transactions and all card not present transactions.

The order insights system and method enables the sharing of information between the cardholder, merchant and financial institution involved with the transaction. The collaboration between these parties via this system and method allows for additional information about the purchase to be obtained after processing, when the cardholder may not recognize the purchase. The sharing of information enables improved cardholder satisfaction, reduces operational expenses for merchants and financial institutions, as well as avoids the filing of chargebacks to dispute the validity of the purchase transaction.

The order insights system performs a process where merchant, order, and transaction information are provided to the issuer. In a preferred embodiment, this information is presented so that the issuer can provide the information to the cardholder to support recognition of the transaction, and thus prevent a chargeback. The level of information provided by the order insights system will vary by merchant and transaction, based on information available and each merchant's ability to provide data in accordance with their technical capabilities and their privacy and other business policies.

For the purposes of preventing a chargeback, maximizing the likelihood that the cardholder will recognize a transaction, and customer satisfaction in general, success depends on the amount and type of information provided. The sources and means of acquiring each part of the information may vary. To facilitate the acquisition and delivery of information most relevant to deflecting chargebacks and other purposes, the order insights system and method may categorize and prioritize the items of information, including such designations as required and supplementary.

In one embodiment, the order insights system will acquire information about transactions from merchants in real time, upon a request by an issuer (real-time acquisition). In such an embodiment, the order insights system will utilize a network, API, web portal, or other connection to a participating merchant. The protocol for information exchange may be one defined as part of the order insights system and to which the merchant conforms, or one defined by the merchant for which a compatible component is included in the order insights system. The protocol may include a process of connecting to multiple systems to acquire the entirety of the information, and may further involve the use of one or more intermediary systems. In this embodiment, the order insights system may elect to store the retrieved information locally to avoid having to acquire the same information in response to subsequent requests from the issuer regarding the transaction. The election by the order insights system whether or not to store the information locally may be based on technical, contractual, or other conditions.

In another embodiment, the order insights system will acquire information about transactions from merchants without a prior request from an issuer, and generally in advance of issuer requests (advanced acquisition). Such acquisition may by initiated by the merchant either upon execution of each transaction or subsequently, either by individual transaction or batches of transactions. Acquisition may alternatively be initiated by the order insights system on a scheduled or manually-initiated basis. Means of information acquisition may be accomplished similarly to those described in the case of real-time acquisition. Furthermore, in this embodiment, the order insights system may include an API and services for accepting connections from merchants.

In another embodiment, the order insights system is associated with a third party provider component and acquires information about transactions as those transactions are processed by the third party (third party acquisition).

In another embodiment, information that is independent of transactions, including information about merchants and payment descriptors, is collected as individual elements and aggregated by the order insights system (aggregated acquisition). Submission of this information may be made by individuals via a web portal or other user interface.

A preferred embodiment of the disclosure may make use of a plurality of information sources and acquisition means, such as those described above.

Examples of the order information that may be provided by the order insights system to the issuer may include:
Payment Descriptor Details, including merchant name, DBA names, phone numbers, email addresses, website addresses, and the website or mobile app linked to the payment descriptor. Using aggregated acquisition, described above, the order insights system may provide information about merchants who do not directly participate in the order insights system directly.
Order Details, such as customer name, IP address where an online order originated, location of purchase, ID of device used to initiate the purchase, image or voice recording and details of each individual item or service purchased.
Customer Relationship, such as whether the cardholder's account has been open for over six months.
Transaction History, including recent purchases.
Dispute History, including disputes, refunds, and chargebacks by the cardholder or relating to the device from which the order originated.
User Verification, nature of the evidence used to confirm the cardholder's identity or validity of the transaction.

The information provided the issuer through the order insights system may include details similar to those provided by merchants when contesting a cardholder chargeback. It may also include information that will help the cardholder to recognize transactions. Thus, the information, and its availability to cardholders via issuers, is valuable for general cardholder satisfaction, preventing chargebacks, and increasing the efficiency of the resolution process when a chargeback is filed.

An issuer may receive the information and make all or some of the information available via the issuer's web site, mobile app, or other means directly to cardholders. Cardholders able to access the order insights information in this manner may be more likely to recognize transactions or conclude that a chargeback would be ineffective, thus avoiding the cost for the issuer to handle a chargeback or even a phone call from the cardholder.

The availability of the order insights information while addressing an inquiry from a cardholder better enables an issuer to help the cardholder recognize transactions. Simply being able to provide the cardholder with more complete information about transactions than can be provided by issuers without access to the order insights system is valuable to the issuer because it facilitates cardholder satisfaction and customer retention. The prevention of chargebacks and the deflection of a dispute using the information maximizes operational savings for the issuer and protects revenue for the merchant.

When a dispute or chargeback is filed, the issuer is able to use the order insights information during the resolution process. Having this information from the order insights system readily accessible and organized reduces the time and effort otherwise needed by the issuer. Thus, the issuer has lower costs when handling cardholder disputes and is also able to improve the response time back to the cardholder.

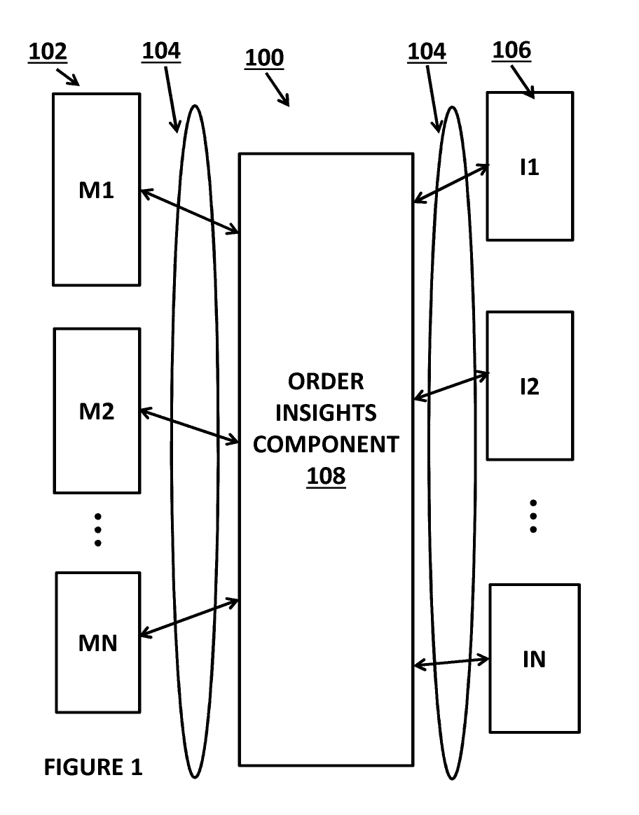

FIG. 1 illustrates an order insights system 100. In the system, one or more merchants using computing devices 102, such as M1, M3, . . . , MN, may access and interact with the order insights system 100 over a communications path 104 using known communication and data transfer protocols. Alternatively, the order insights system 100 may access and interaction with merchant computing systems 102. Each merchant provides information about each transaction that may be acquired by the order insights system 100 and made available to issuers for the purposes of enabling cardholders to recall the purchase and avoid a billing dispute for a particular transaction and increased customer satisfaction.

The system 100 also may allow one or more issuers using computing devices 106, such as I1, I2, . . . , IN as shown in FIG. 1, to couple to and interact with the order insights system 100 over a communications path 104 using known communication and data transfer protocols.

In the system, each computing device 102, 106 may be a computer system with a processor that has the appropriate capabilities to couple to/connect with and interface with the order insights system 100. For example, each computing device may be a smartphone device, a personal computer, a laptop or tablet computer, a terminal, and the like. Each computing device 102, 106 may include a user interface component such as app, web browser, or other functionality. Each computer device 102, 106 may further be an automated computing device, such as a server, that access and interacts with the order insights system 100 without direct user control, such as on an automatic, scheduled basis or in response to external activity, such as the execution of a transaction by a payment system. The commutations path 104 may be a wired network, wireless network, or a combination of the two that allow each computing device is interact with the order insights system 100 and can use any communication protocol and/or any data transfer protocol.

The order insights system 100 may be implemented using one or more computing resources. The one or more computing resources may include a processor, memory, a server computer, a database server, an application server, a blade server and the like. In some embodiments, the computing resources which comprise the order insights system 100 may be hosted on and executed by the same server computer, but may be geographically distributed. In this system, the order insights system 100 may be implemented in hardware or software. When the order insights system component 100 is implemented in software, the order insights system 100 may be a plurality of lines of computer code that may be executed by a processor of the computer system hosting the order insights system 100 to implement the functions and operations of the system. As described in more detail below, the order insights system 100 enables access to detailed order, location, and account activity information from the merchant when a cardholder is questioning a charge or requesting to file a dispute for the particular transaction using the card of the issuer. The order insights information may be made available via the bank website, mobile app, or via the call center customer care team to assist the cardholder with recalling the transaction in order to increase customer satisfaction and try to avoid the filing of a chargeback by the cardholder.

The order insights system 100 enables access to information that is not currently easily accessible to cardholders or members of the issuer's customer care team. Commonly, a cardholder contacts the bank to dispute a charge because the cardholder does not recognize the merchant name or simply the cardholder does not recall the purchase. When a cardholder calls into an issuer call center to inquire or dispute a transaction, the call center agent can access the order insights system data in various manners. For example, the agent may be able to log into a portal of the order insights system 100 or access and request the information via an API. This information may be used by the agent of the issuer so that the cardholder recognizes the transaction and enable a more informed decision as to proceeding with a chargeback or accepting that the charge was valid.

The order insights system 100 may identify a standard set of fields and order attributes for the exchange of information between the merchant and the issuer. Merchants will choose to provide all or a sub-set of these attributes based on the information stored and maintained on their systems and their policies as described above. The order insights system 100 is designed to enable the broadest exchange of information to improve the cardholder experience and enable recognition of charges to reduce the number of disputes submitted for processing.

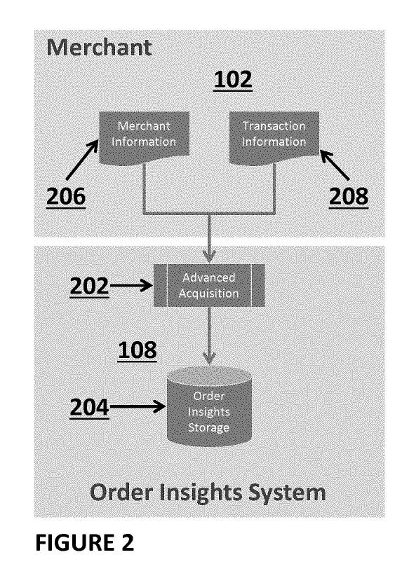

FIG. 2 illustrates the data flows of the components of the order insights system 100 when gathering merchant and transaction information using the advanced acquisition process. A merchant 102 has merchant information 206 or transaction information 208 (as well as other types of information as described above) which is transmitted to the advanced acquisition component 202 of the order insights system 100. The advanced acquisition component 202 receives the information and stores it in the order insights storage 204.

The connection between the merchant 102 and the order insights system 100 for the purposes of transmitting the merchant information 206 and transaction information 208 in this example may be initiated by either the merchant 102 or the order insights system 100 upon the occurrence of predefined events, according to a regular schedule, or upon manual invocation. The advanced acquisition component 202 may be an application programming interface (API) or other protocol for the exchange of files in a previously-agreed format. The order insights system 100 may define data structures, required data, and supplementary data that is handled by the advanced acquisition component 202.

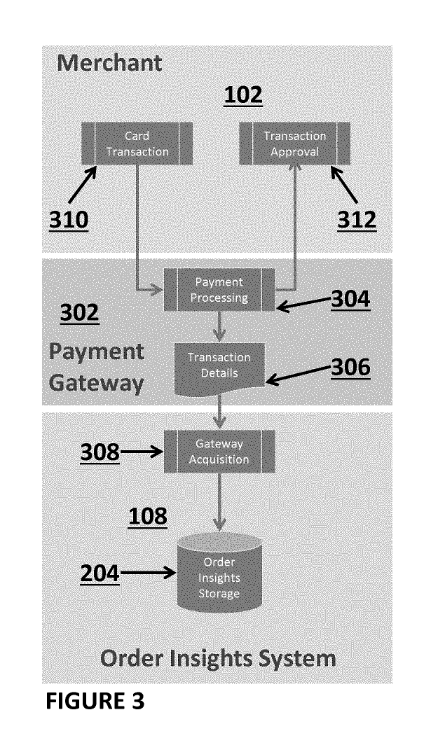

FIG. 3 illustrates the data flows of the order insights system 100 when gathering transaction information using the third party acquisition process. A merchant 102 has a card transaction 310 it wishes to execute, for example a debit card payment from a cardholder on the merchant's website. Commonly, a merchant 102 will utilize the services of one or more third party providers 302 such as payment gateways, order management systems or ecommerce shopping carts to approve and process card transactions. The merchant 102 will send the card transaction 310 to the payment processing component 304 of the third party provider 302 and will receive a transaction approval 312 if the transaction was successfully processed. Additionally, the third party provider 302 will extract the transaction details 306 and merchant information 307 (as well as other types of information as described above) and send to, or make them available to, the order insights system 100. Within the order insights system 100, the third party acquisition component 308 will receive or collect the transaction details 306 and merchant information 307 (as well as other types of information as described above) and store the information in the order insights storage 204.

The third party provider component 302 and the order insights system 100 may be contained within a single encompassing transaction processing system or they may be separate systems entirely. They may communicate directly, such as through physical memory, shared databases, wired or wireless networks, or may utilize intermittent communications means such as email or file exchange. The third party acquisition component 308 will accept or retrieve transaction details 306 and merchant information (as well as other types of information as described above) according to protocols, formats, required and supplementary data elements defined to be compatible for data exchange between the third party provider component 302 and the order insights system 100.

The transmission of transaction details 306 and merchant information (as well as other types of information as described above) to the third party acquisition component 308 may occur synchronously or asynchronously with the other functions performed by the payment processing component 304. FIG. 3 illustrates a direct data flow from the payment processing component 304 to the order insights system 100, but it will be appreciated by those skilled in the art that there are many other possible data flows that are similar in spirit and achieve the same effect. For example, there may be one or more other components within the third party provider component 302 which handle the extraction, packaging, and transmission of transaction details to the order insights system 100, and these components may contain other business logic such as selecting which transactions are eligible for transmission to the order insights system 100 and when the transactions are transmitted to the order insights system 100.

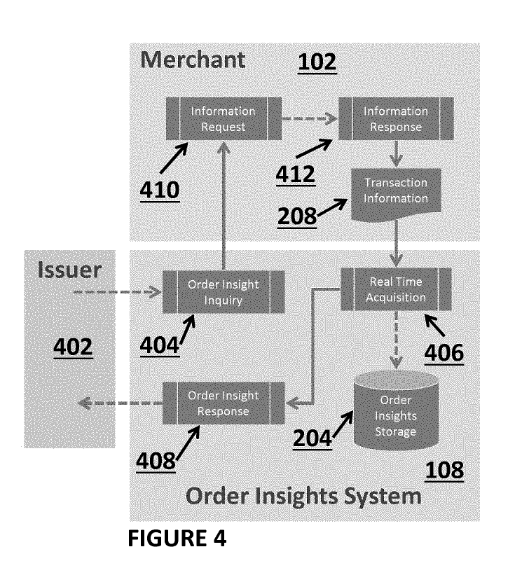

FIG. 4 illustrates the data flows of the order insights system 100 when processing information in accordance with the real time acquisition approach. Upon receipt of an order insights request from an issuer 402, an order insights inquiry process 404 determines that the transaction information must be requested from the corresponding merchant 102 to satisfy the request from the issuer 402. The order insights inquiry process 404 submits an information request 410 to the merchant 102, which, in turn, causes an information response process 412 to send transaction information 208 back to the order insights system 100. Within the order insights system 100, the real time acquisition component 406 receives the transaction information 208 and uses it to construct an order insights response 408 which is communicated to the issuer 402. The real time acquisition component 406 may further store the transaction information 208 in the order insights storage 204 depending on business logic, configuration options, storage capacity, merchant policies, and the like.

It will be appreciated that the process of real time acquisition may nevertheless utilize or rely upon synchronous or asynchronous elements. The data flow may involve one or more intermittent, store-and-forward, or batch communication systems.

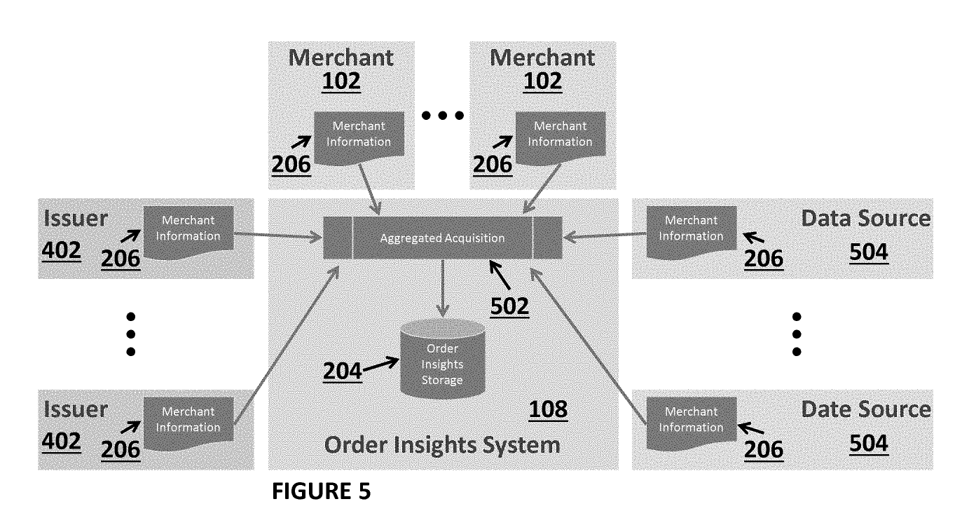

FIG. 5 illustrates the data flows of the order insights system 100 related to aggregated acquisition component 502 of merchant information 206. As merchant information 206 is relatively static and not tied to specific transactions, the merchant information 206 can be collected by the order insights system 100 at any time and from any source. Merchant information 206 may include the identification of the merchant who owns a particular payment descriptor, trade names or DBA names under which the merchant is known to cardholders, contact information for the merchant, and the like. Merchant information may also contain generally useful or informative elements such as the merchant's product return and refund policies, business hours, web site addresses, and the like. The order insights system 100 allows merchant information 206 to be collected piecemeal and for it to be amended, updated, and corrected subsequent to the initial collection.

An aggregated acquisition component 502 within the order insights system 100 provides one or more methods or interfaces which permit the submission of merchant information 206. These methods may include web portals, mobile apps, and similar methods for use directly by individuals entering the data, and they may include APIs and protocols for use by computing systems. Individuals or computing systems within issuers 402, merchants 102, and elsewhere representing a variety of types of data sources 504 submit the merchant information 206 to an aggregated acquisition component 502 within the order insights system 100. The aggregated acquisition component 502 stores the merchant information 206 in the order insights storage 204, performing any necessary additions, deletions, and updates to existing merchant information.

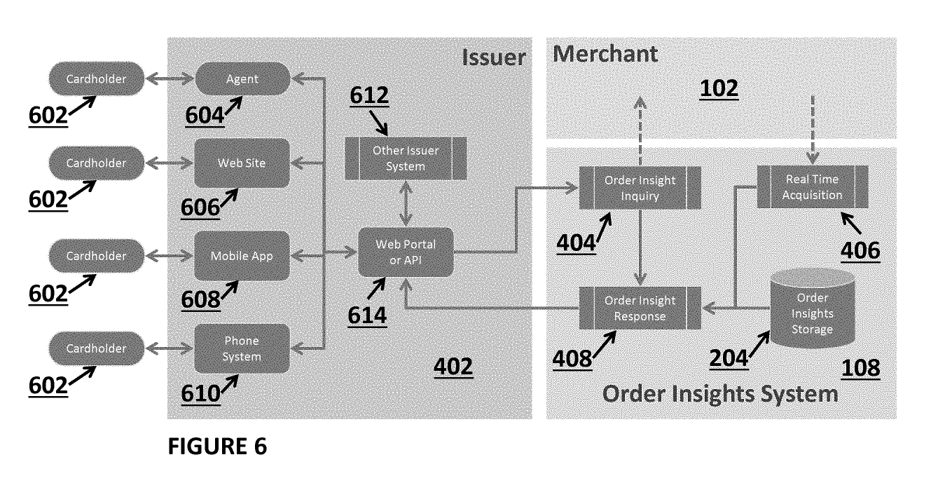

FIG. 6 illustrates the data flows of the order insights system 100 as utilized by issuers 402. Commonly, an issuer 402 will provide various means to cardholders 602 to access their account information or submit inquiries to the issuer 402. A cardholder 602 may connect to a service provided by an issuer 402 such as customer service agent via a branch or telephone 604, the issuer's website 606, an application on their mobile phone or tablet 608, an automated phone system 610, and the like. It will be appreciated that these are merely examples and issuers 402 may provide other means for cardholders to contact the issuer or make inquiries.

Additionally, an issuer may have one or more processes or services 612 which may take advantage of the order insights system 100 and the information it provides. These other issuer systems 612 may or may not provide interactive user interfaces, and may invoke the order insights system 100 in response to user action, business logic, or otherwise. For example, when a chargeback is being processed through an issuer's internal systems, those systems may receive transaction information from the order insights system in order to facilitate the chargeback resolution process.

Whether as a result of direct or indirect interaction with a cardholder 602, or the execution of another issuer system 612, a request is made to the order insights system 100 via a web portal, API, or other provided service interface 614. The order insights inquiry 404 causes the order insights system 100 to produce an order insights response 408 which is returned to the issuer 402 by way of the web portal, API, or other service 614. In the process of producing the order insights response 408, the order insights system 100 may request information from a merchant 102 via the real time acquisition process 406, retrieve information from the order insights storage 204, or both. Further, the order insights system 100 may determine that no relevant information is available, in which case the order insights response 408 will so indicate.

Upon receipt of the order insights response 408 via the web portal, API, or other service 614 to the call center agent 604, issuer web site 606, issuer mobile application 608, interactive phone system 610, or other component, the information from the order insights system 100 is utilized, conveyed, or applied in the manner desired by the issuer. In a preferred scenario, the issuer 100 is able to provide sufficient information about a transaction to the cardholder 602 to enable the cardholder 602 to recognize the transaction and to prevent the filing of a chargeback.

The data flows illustrated in FIG. 6 may be synchronous or asynchronous. Nothing about the intended design relies upon nor excludes specific data flow initiation or timing, such as predictively fetching information about merchants, payment descriptors, or cardholder transactions or the caching of information by the issuer to avoid repeated retrieval of duplicate data from the order insights system.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. The modules also can comprise programming instructions transmitted to a general purpose computer or to processing/graphics hardware via a transmission carrier wave. Also, the modules can be implemented as hardware logic circuitry implementing the functions encompassed by the innovations herein.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for facilitating the sharing of merchant and/or order information between one or more entities comprising:
receiving a request for information about an order, the request containing one or more data elements that allows the one or more of the merchant and the order to be identified;
locating information about one or more of the merchant and the order using one or more of real-time acquisition, advanced acquisition and aggregated acquisition; and
responding to a requestor with one or more of the merchant information and the order information.

2. The method of claim 1, wherein the request for information is for a particular transaction.

3. The method of claim 2 further comprising determining eligibility of the requestor to receive the information and providing the information if a particular transaction is from a participating merchant.

4. The method of claim 1, wherein the information further comprises crowd sourced merchant data and order data.

5. The method of claim 1, wherein the information further comprises one or more of merchant details information, order details information, customer relationship information, a transaction history, a dispute history, a usage history and a proof of profile verification.

6. The method of claim 1 further comprising receiving a notification from a cardholder to request the information.

7. The method of claim 1, wherein the requestor is an issuer who is performing an investigation.

8. The method of claim 7, wherein the notification from the cardholder is one of a call initiated into a call center of an issuer, a trigger through one of a portal and an application, a notification using a mobile application, a notification in response to a user at a website and a notification based on a cardholder presence at a location of an issuer.

9. The method of claim 1 further comprising assisting the requestor to recognize a transaction based on one or more of merchant information and order information.

10. The method of claim 1 further comprising preventing a filing of a dispute by the requestor based on one or more of merchant information and order information.

11. The method of claim 1, wherein locating the information further comprises collecting the information as the information traverses a third party provider system.

12. The method of claim 1, wherein locating the information further comprises collecting the information from each merchant in a periodic batch.

13. The method of claim 1, wherein locating the information further comprises collecting the information from a merchant after each transaction.

14. The method of claim 1, wherein locating the information further comprises collecting the information for a merchant while responding to the requestor.

15. The method of claim 1, wherein locating the information further comprises collecting the information for one or more sources.

16. An apparatus, comprising:
an order insights system executed on a processor so that the processor is configured to receive a request for information about an order, the request containing one or more data elements that allows the one or more of the merchant and the order to be identified;
the processor further configured to locate information about one or more of the merchant and the order using one of real-time acquisition, advanced acquisition and aggregated acquisition; and
the processor further configured to respond to a requestor with one or more of the merchant information and the order information.

17. The apparatus of claim 16, wherein the request for information is for a particular transaction.

18. The apparatus of claim 17, wherein the processor is configured to determine eligibility of the particular transaction to receive the information and to provide the information if the particular transaction is from a participating merchant.

19. The apparatus of claim 16, wherein the information further comprises crowd sourced merchant data and order data.

20. The apparatus of claim 16 wherein the information further comprises one or more of merchant details information, order details information, customer relationship information, a transaction history, a dispute history, a usage history and a proof of profile verification.

21. The apparatus of claim 16, wherein the processor is configured to receive a notification from a cardholder of the information request.

22. The apparatus of claim 16, wherein the requestor is an issuer who is performing an investigation.

23. The apparatus of claim 22, wherein the notification from the cardholder is one of a call initiated into a call center of an issuer, a trigger through one of a portal and an application, a notification using a mobile application, a notification in response to a user at a website and a notification based on a cardholder presence at a location of an issuer.

24. The apparatus of claim 16, wherein the processor is configured to assist the requestor to recognize a transaction based on one or more of merchant information and order information.

25. The apparatus of claim 16, wherein the processor is configured to prevent a filing of a chargeback by the requestor based on one or more of merchant information and order information.

26. The apparatus of claim 16, wherein the processor is configured to collect the information as the information traverses a third party provider system.

27. The apparatus of claim 16, wherein the processor is configured to collect the information from each merchant in a periodic batch.

28. The method of claim 16, wherein the processor is configured to collect the information from a merchant after each transaction.

29. The method of claim 16, wherein the processor is configured to collect the information for a merchant while responding to the requestor.

30. The method of claim 16, wherein the processor is configured to collect the information for one or more sources.
